(19) United States
(12) Patent Application Publication
(10) Pub. No.: US 2025/0358131 A1
(43) Pub. Date: Nov. 20, 2025

(54) Method And Systems For Integrity-Secured Transmission Of At Least One Measurement Data Point

(71) Applicant: Siemens Aktiengesellschaft, München (DE)

(72) Inventor: Sebastian Bode, Ahlen (DE)

(73) Assignee: Siemens Aktiengesellschaft, München (DE)

(21) Appl. No.: 19/210,869

(22) Filed: May 16, 2025

(30) Foreign Application Priority Data
May 17, 2024 (DE) 10 2024 204 633.7

(51) Int. Cl. H04L 9/32; H04L 9/30

(52) U.S. Cl. CPC H04L 9/3247; H04L 9/30

(57) ABSTRACT

Some embodiments include methods for integrity-securing transmission of a measurement data point from a control device to an auxiliary device. This transmission is cryptographically unsecured. On the receiver side, the measurement data point is converted into a cryptographically secured representation. The measurement data set is transmitted cryptographically unsecured and then gradually converted into other representations, until finally a cryptographically secured representation is generated, which is checked for assignability to or agreement with a representation stored or retained in the control device CTR. Substantial parts of the processing on the side of the control device CTR can be delayed to a time period in which more computer resources are available than at the time of reception of the confirmation message.

### CROSS-REFERENCE TO RELATED APPLICATIONS

This application claims priority to DE Application No. 10 2018 201 279.2 filed Jan. 29, 2018, the contents of which are hereby incorporated by reference in their entirety.

### TECHNICAL FIELD

The present disclosure relates to data handling. Various embodiments of the teachings herein include systems and/or methods for integrity-secured transmission of at least one measurement data point.

### BACKGROUND

In the prior art, methods for the integrity-secured transmission of measurement data may be used to ensure or at least plausibility-check the fact that a measurement data point has been transmitted uncorrupted, unaltered and/or authentically. Technical measures to ensure integrity are usually aimed at detecting faulty data as such and, if necessary, repeating the data transmission. A simple way to protect against transmission errors is a checksum that is transmitted along with the data and allows the receiver to detect whether the data has been altered. However, this known checksum does not protect against intentional or malicious alteration or manipulation of measurement data.

Known measures for integrity-secured transmission are often solved on the basis of exclusive point-to-point connections and therefore involve separation of the transmission validation from the actual technical tasks of the devices involved, in particular measurement and display tasks. Furthermore, these measures require the use of special or more powerful components, which means that the system architecture of the devices has little flexibility, for example to implement updates of the device firmware in the form of over-the-air updates.

### SUMMARY

Teachings of the present disclosure include systems and methods for integrity-secured transmission, which shift the measures necessary for ensuring transmission integrity for establishing and verifying the integrity further away, compared to known methods, from the side of the auxiliary device as the authoritative receiver of measurement data onto the control device as the main source of the measurement data.

For example, some embodiments include a method for the integrity-secured transmission of at least one measurement data point from a control device (CTR) to at least one auxiliary device (DSP) communicatively connected to the control device (CTR), the method comprising: collecting at least one measurement data set; generating and maintaining a cryptographically secured first representation of the measurement data set in the control device (CTR); sending at least one cryptographically unsecured transmission message containing the at least one measurement data set to the auxiliary device (DSP); receiving a confirmation message from the auxiliary device (DSP), the confirmation message at least containing a cryptographically secured second representation of a measurement data set; checking the assignability of the received cryptographically secured second representation to the cryptographically secured first representation of the measurement data set provided in the control device (CTR); and verifying the integrity of the transmitted measurement data set, based on a positive result of the test.

In some embodiments, the cryptographically secured representation is generated with a cryptographic hash function or with a digital signature.

In some embodiments, the received cryptographically secured second representation is decrypted by means of a public signature key assignable to the auxiliary device (DSP) before the assignability is checked.

In some embodiments, after verification of the integrity of the transmitted measurement data set, the received cryptographically secured second representation is signed with a private signature key assignable to the control device (CTR) and sent to the auxiliary device (DSP).

In some embodiments, the confirmation message received by the auxiliary device (DSP) is sent in response to the transmission message.

In some embodiments, upon receipt of the confirmation message, a check is performed as to whether said message has been sent in response to one of the at least one transmission messages.

In some embodiments, the check of the assignability comprises checking for identity or agreement.

In some embodiments, the cryptographically secured representation is generated with a digital signature in conjunction with a certificate chain derived from a certificate.

In some embodiments, an initially set validity of said certificate or another certificate within the certificate chain is limited to an initial statutory calibration period of the control device (CTR) and/or the auxiliary device (DSP).

As another example, some embodiments include a control device for the integrity-secured transmission of at least one measurement data point to at least one auxiliary device (DSP) communicatively connected to the control device (CTR), the control device (CTR) being configured for carrying out one or more of the methods as described herein.

As another example, some embodiments include an auxiliary device for the integrity-secured reception of at least one measurement data point from at least one control device (CTR) communicatively connected to the auxiliary device (DSP), the auxiliary device (DSP) being configured for carrying out one or more of the methods described herein.

### BRIEF DESCRIPTION OF THE DRAWINGS

Further exemplary embodiments and advantages of the teachings herein are explained in more detail below with reference to the drawing. In the figures:

FIG. 1: shows a schematic sectional illustration of an example control device and an auxiliary device incorporating teachings of the present disclosure;

FIG. 2: shows a schematic illustration of a first example method incorporating teachings of the present disclosure;

FIG. 3: shows a schematic illustration of a second example method incorporating teachings of the present disclosure;

FIG. 4: shows a schematic illustration of a third example method incorporating teachings of the present disclosure;

FIG. 5: shows a schematic illustration of a fourth example method incorporating teachings of the present disclosure; and

FIG. 6: shows a schematic illustration of a fifth example method incorporating teachings of the present disclosure.

### DETAILED DESCRIPTION

Some embodiments of the teachings herein include a method for integrity-secured transmission of at least one measurement data point from a control device to at least one auxiliary device that is communicatively connected to the control device. An example method comprises, without regard to their sequence, the elements:
collecting at least one measurement data set comprising at least the measurement data point;
generating and maintaining a cryptographically secured first representation of the measurement data set in the control device;
sending at least one cryptographically unsecured transmission message containing the at least one measurement data set to the auxiliary device;
receiving a confirmation message—in particular sent in response to the transmission message—which can optionally be checked to determine whether it has been sent in response to the at least one transmission message—from the auxiliary device, the confirmation message at least containing a cryptographically secured second representation of a measurement data set;
checking the assignability—in particular identity or agreement of the received cryptographically secured second representation to the cryptographically secured first representation of the measurement data set stored in the control device; and
verifying the integrity of the transmitted measurement data set, based on a positive result of the test.

The integrity of the transmission is verified by the transmitter—that is, the control device—and not by the receiver. Complex and computationally intensive cryptographic operations—including the associated maintenance tasks such as key rotation, etc.—are implemented predominantly on the transmitter side, i.e. on the side of the control device. The auxiliary device on the receiver side has, in comparison, a less computationally intensive obligation to form a confirmation message that contains a cryptographically secured second representation, for example a signature, of a measurement data set. As an example, the receiver side must therefore only perform one direction of a one-way function—i.e., for example, form a cryptographic hash value and/or form a signature, for example, encrypt the hash value with a private signature key of an asymmetric key pair—but need not calculate the more computationally resource-intensive counter-direction of this one-way function—in the sense of decryption, for example.

The steps to be performed on the transmitter side of a) checking the assignability of the received cryptographically secured second representation to the cryptographically secured first representation of the measurement data set stored in the control device and b) verifying of the integrity of the transmitted measurement data set can also be temporally shifted such that they occur at a time when computing resources are available for exclusive use in a sufficient amount and/or for sufficient time that there is no need to switch between different processes.

No exclusive communication channels or even point-to-point connections are required. It is not necessary to separate the measurement and display tasks from that of securing the transmission.

The person skilled in the art will understand that a temporal implementation of the method is not necessarily determined by the sequence of the wording of the method steps given in the claim. For example, generating and storing the cryptographically secured first representation of the measurement data set in the control device can alternatively also be carried out after sending the transmission message to the auxiliary device, after receiving the confirmation message from the auxiliary device, or before checking the assignability of the received cryptographically secured second representation.

In some embodiments, the cryptographically secured representation is generated with a cryptographic hash function or with a digital signature.

In some embodiments, the received cryptographically secured second representation is decrypted before the assignability is checked. It can be provided to convert a signature by means of an associated public key into a hash in plain text in order to compare the hash with the cryptographically secured first representation, for example, a retained hashed data copy of the measurement data set or a retained signed data copy of the measurement data set.

In some embodiments, after verification of the integrity of the transmitted measurement data set, the received cryptographically secured second representation is signed with a private signature key assignable to the control device and sent to the auxiliary device. This additional step may be advantageous to give the auxiliary device a cryptographically secured assurance that a verification of the transmission integrity has been carried out by the control device.

In some embodiments, the confirmation message received by the auxiliary device is sent in response to the transmission message.

In some embodiments, upon receipt of the confirmation message, a check is performed as to whether said message has been sent in response to one of the at least one transmission messages. These embodiments, on the one hand, may be a tautological summary of what the teaching of the patent claim already effects overall and exhaustively with the checking of the assignability, on the other hand refinements with additional application of one or both advantageous embodiments may form additional advantages, in particular, if multiple transmission messages are sent and the associated confirmation messages arrive in a staggered manner or are evaluated in a staggered manner.

In some embodiments, checking of the assignability comprises checking for identity or agreement.

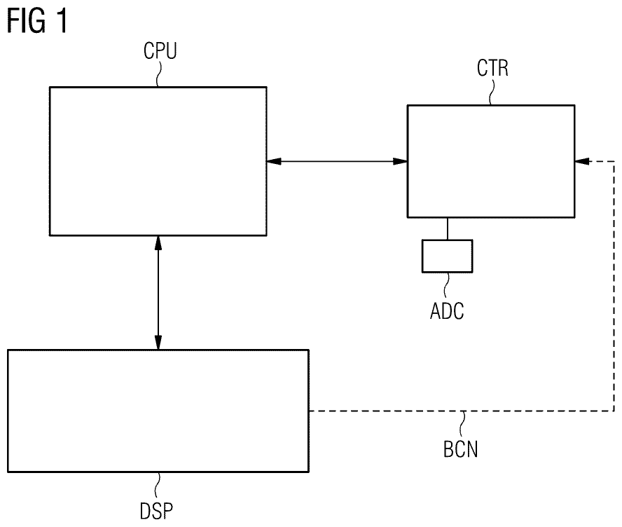

FIG. 1 shows a control device CTR incorporating teachings of the present disclosure, which obtains one or more measurement data items, for example via an analog-to-digital converter ADC. The analog-to-digital converter ADC can either be externally connected to the control device CTR as shown in the drawing, or internally integrated into the control device CTR. A more detailed graphical representation is not used in favor of a concise representation.

In this exemplary embodiment, the control device CTR comprises a microcontroller within a measuring device. Via a bidirectional data connection, the control device CTR is connected to a communication device CPU. This communication device CPU can be implemented, for example, as a data bus, as an industrial data bus or as any electronic module CPU, by means of which an intermediate data connection is set up or operated between the control device CTR and an auxiliary device DSP. The auxiliary device DSP in a simplest configuration is an output device, for example a display, by means of which measurement data collected by the control device CTR are displayed.

A dashed line connects the auxiliary device DSP to the control device CTR. The data link BCN configured with the dashed line is also referred to below as a return link BCN.

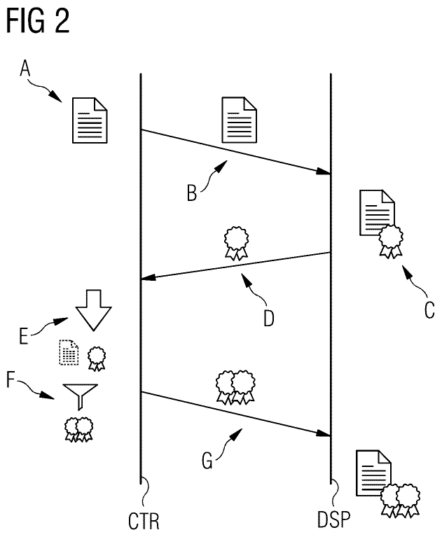

In FIG. 2, an exemplary exchange of control messages, in particular transmission and confirmation messages, between a control device CTR and an auxiliary device DSP is shown in the form of a flow diagram. A communicating function of the communication device CPU is not further elaborated in the illustration of FIG. 2 for reasons of clarity. Thus, only the endpoints of the message exchange, i.e. the control device CTR and the auxiliary device DSP, are considered.

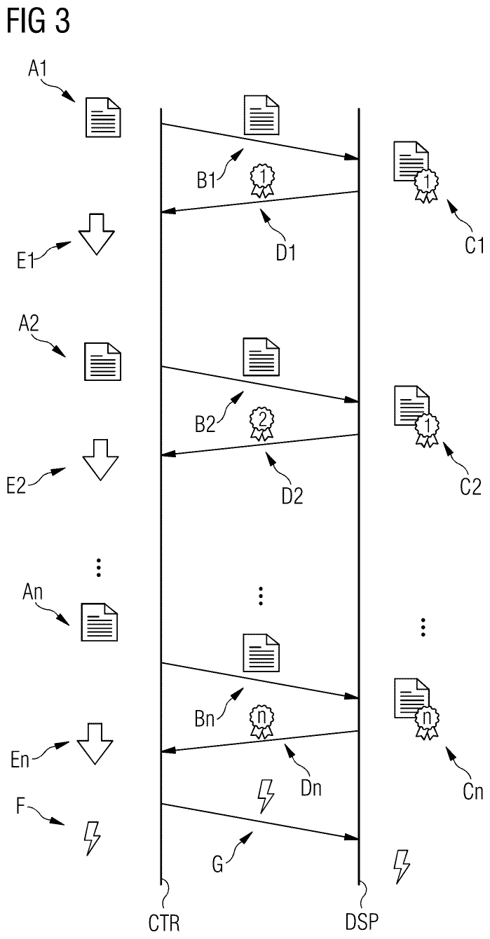

In the representation of the flow diagram according to FIG. 2 and the following FIGS. 3 to 6, successive time points are arranged chronologically in such a way that later time points are shown lower down than earlier time points. For each of the function units CTR, DSP, a vertical line is drawn in each case to represent the message exchange of these function units CTR, DSP with respect to the respective transmission or reception time, taking into account the progress of time.

In a first step of the exemplary method, a measurement data set A is collected. In a second step B, the measurement data set is sent to the auxiliary device DSP in a cryptographically unsecured transmission message. The measurement data set is thus inserted unchanged, for example, into a data frame, into a data packet or into a file, which is sent to the auxiliary device DSP.

The cryptographically unsecured transmission message is received at the auxiliary device DSP and the cryptographically unsecured measurement data set is extracted from the transmission message. In a subsequent method step C, the measurement data set is converted on the side of the auxiliary device DSP into a cryptographically secured representation, which in the following is also referred to as a cryptographically secured second representation of the measurement data set. Such a cryptographically secured second representation can be produced by forming a hash value and/or by signing the measurement data set with the private key of an asymmetric signature key pair assigned to the auxiliary device DSP.

In a method step D, the cryptographically secured second representation of the measurement data set is inserted into an otherwise cryptographically unsecured confirmation message, which is sent to the control device CTR. In a subsequent method step E, the cryptographically secured second representation of the measurement data set is extracted from the confirmation message and, depending on the respective exemplary embodiment, fed to a further processing stage. Such further processing may consist, for example, of the signature of the cryptographically secured second representation being decrypted using an associated public key of the auxiliary device DSP and converted into a hash representation in plain text.

In a further step, a cryptographically secured first representation of the measurement data set stored in the control device CTR can also be generated, provided that this has not been previously generated. In the latter case, the stored representation is used. In some embodiments, the retained measurement data set is converted at this point in time into a cryptographically secured first representation—for example in the form of a hash value. A subsequent method step F comprises checking the assignability of the received cryptographically secured second representation to the cryptographically secured first representation of the measurement data set stored in the control device CTR. If the assignability, i.e. for example the identity, of the two representations is given, the integrity of the originally transmitted measurement data set is or will be confirmed.

The methods described herein are designed in such a way that a sequence of the method steps is essentially arbitrary. This means that the described method steps can also be carried out in a different sequence or in large part in parallel. Depending on the embodiment, the method comprises a first step in which the measurement data set is transmitted cryptographically unsecured and then gradually converted into other representations, until finally a cryptographically secured representation is generated, which is checked for assignability to or agreement with a representation stored or retained in the control device CTR. By means of these measures, in particular, substantial parts of the processing on the side of the control device CTR can be delayed, that is, in particular, postponed to a time period in which more computer resources are available than at the time of reception of the confirmation message. Alternatively, substantial parts of the processing on the side of the control device CTR can also be postponed to a time period in which computer resources are not otherwise required for an extended period of time.

On the receiver side, i.e. on the side of the auxiliary device DSP, received measurement data sets or representations derived therefrom are converted into a cryptographically secured representation. This cryptographically secured representation can be a cryptographic signature, but also a summary of the data set, e.g. in the form of a cryptographic hash value, which can then be transferred via a secure connection—not necessarily a cryptographically secured connection.

Such a secure connection may be, for example, the secured return connection BCN shown in FIG. 1. In particular, the secured return connection BCN can be a point-to-point connection. It is also conceivable to use a monitored communication interface such as a CAN bus. Another possible version of this return connection is an optical interface consisting of a light-emitting diode and a phototransistor. The cryptographically secured representation is then transmitted to the transmitter side, where a check is performed to determine whether it corresponds to the data available there. Depending on the test result for verification of transmission integrity, an action related to the data transmission can be performed, in the simplest case the output of a confirmation.

FIG. 3 shows an example of a transmission of a plurality of measurement data sets A1, . . . , An from the control device CTR to the auxiliary device DSP. The auxiliary device DSP in the exemplary embodiment shown in FIG. 3 generates a cryptographically secured second representation of the respectively received measurement data set, which takes place in each case after the reception of the transmission message B1, . . . , Bn.

In a respective method step C1, . . . , Cn the auxiliary device DSP forms a cryptographically secured second representation, for example a hash value, of the respectively received measurement data set.

In a subsequent method step, the cryptographically secured second representation of the measurement data set is inserted into an otherwise cryptographically unsecured confirmation message D1, . . . , Dn, which is sent to the control device CTR. In a subsequent respective method step E1, . . . , En, the cryptographically secured second representation of the measurement data set is extracted from the respectively received confirmation message by the control device CTR and is fed to a further processing stage.

A subsequent method step F comprises checking the assignability of the received cryptographically secured second representation to the cryptographically secured first representation of the measurement data set provided in the control device CTR. Depending on a result of the assignability check, the integrity is either verified or falsified cumulatively—i.e. across all representations of the measurement data set. In the illustrated case of a falsifying method step F, a blocking message can be sent in a method step G to the auxiliary device DSP, which, due to the absence of integrity in one of the described data transmissions, may initiate further measures if necessary, for example, blocking of the display for the non-integral measurement values.

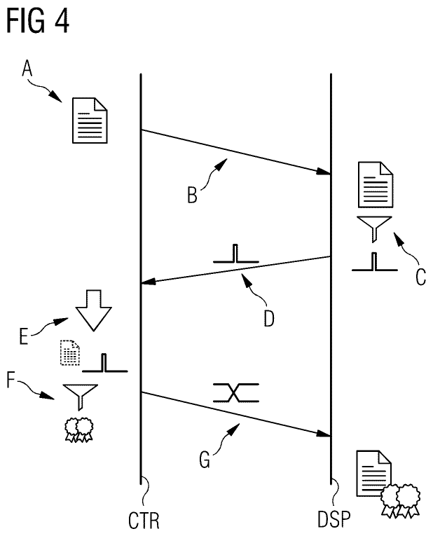

FIG. 4 shows a further embodiment variant which differs from the aforementioned methods in that the returned cryptographically secured second representation of the measurement data set D occupies a smaller size than in the aforementioned exemplary embodiments according to FIGS. 2 to 3. In the exemplary embodiment shown in FIG. 4, the measurement data set received by the auxiliary device DSP in step B is converted into a cryptographically secured second representation C and the auxiliary device DSP checks whether this second representation C agrees with an expected representation. If this is the case, in a subsequent method step D, a confirmation pulse or acknowledgment pulse D is sent via a return connection, for example via the secured return connection BCN shown in FIG. 1 or an otherwise secured data connection, for example by briefly switching an LED of an optical transmission link.

Method step E could be conceptually equivalent in the broadest sense to determining a parity. When evaluating a bit, however, on average one pulse would need to be transmitted for each two messages, in the case of one byte one more pulse for each 256 messages, and in the case of 2 bytes one pulse for each 65,536 messages. Using a full SHA256 hash value, for example, could prove less favorable due to the small number of pulses relative to the number of messages transmitted (about 1:10⁷⁷). In method step E it is therefore more advantageous to convert a retained representation of the measurement data set A into a hash value by means of a hash function and in doing so to determine, as part of a check of the assignability of the received confirmation pulse or pulses to the retained representation of the measurement data set A, when to expect a pulse and, if applicable, how many pulses.

In a method step F for verifying the integrity, it is finally determined cumulatively whether all or at least several of the expected confirmation pulses have arrived as expected. Depending on a positive result of the check, a method step G is optionally carried out, according to which, for example, an inversion of an output signal is initiated on a CAN bus (Controller Area Network) or on a CSMA/CR channel (Carrier Sense Multiple Access/Collision Resolution) of a fieldbus, in order to send, in a method step G subsequent to the verifying method step F, an enable message to the auxiliary device DSP which, due to the given integrity, may initiate further measures, for example, a display for the integral measurement values.

In a variant of the embodiment shown in FIG. 4—not shown in the drawing—parts of the transmission message transmitted in method step B are used in method step C as a message in the sense of method step C. For example, the method according to step C can be based on bytes and for this purpose the messages from step B can be decomposed into bytes.

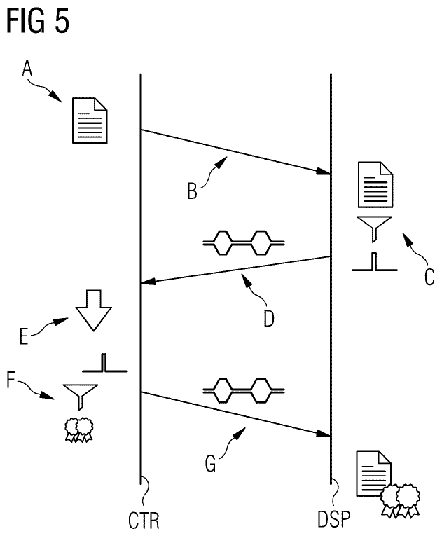

FIG. 5 shows a further embodiment, which differs from the aforementioned embodiments in particular in that this one may be more suitable for use in a CAN bus. In the exemplary embodiment shown in FIG. 5, the measurement data set received by the auxiliary device DSP in step B is converted into a cryptographically secured second representation C and the auxiliary device DSP checks whether this second representation C agrees with an expected representation. If this is the case, in a subsequent method step D, the cryptographically secured second representation of the measurement data set is inserted into an otherwise cryptographically unsecured confirmation message, which is sent via a CAN bus to the control device CTR. The sending of the confirmation message in method step D means in this case that the cryptographically secured second representation of the measurement data set is transferred to the CAN bus, which is monitored for transmitted data by the control device CTR.

In a subsequent method step E, the cryptographically secured second representation of the measurement data set is extracted from the CAN bus and fed to a further processing stage. Such further processing may consist, for example, of the signature of the cryptographically secured second representation being decrypted using an associated public key of the auxiliary device DSP and converted into a hash representation in plain text.

A subsequent method step F comprises checking the assignability of the received cryptographically secured second representation to the cryptographically secured first representation of the measurement data set provided in the control device CTR. Depending on the result of the assignability check, the integrity of the transmission over the CAN bus is either verified or falsified. In the illustrated case of a verifying method step F, an enable message can be sent in a method step G to the auxiliary device DSP, which, due to the absence of integrity in one of the described data transmissions, may initiate further measures if necessary, for example, enabling the display for the integral measurement values. In the case of the CAN bus, the enabling is effected, for example, as shown in the diagram, by an inversion of an output signal on the CAN bus.

In some embodiments, the control device CTR and the auxiliary device DSP simultaneously send the respective cryptographically secured representation of the measurement data set and determine whether a collision occurs. In this way, both sides can assess at the same time whether a discrepancy has occurred.

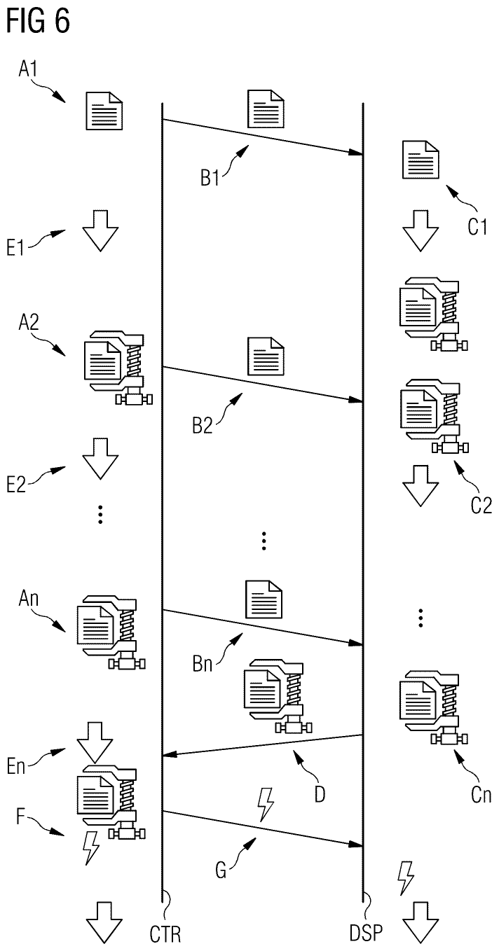

FIG. 6 shows a further embodiment for which, in particular, the communication device CPU from FIG. 1 can be used. This embodiment differs from the aforementioned embodiments in particular in that the method steps A1, . . . , An; B1, . . . , Bn; C1, . . . , Cn and E1, . . . , En; are carried out multiple times—e.g. n times, as shown in the diagram—but the method steps D, F, G only once. This embodiment is intended to clarify the principle—which is of course also applicable to the aforementioned embodiments—that the processing of the method steps can also be stream-orientated, i.e. on different sizes of subsets of a total data set, wherein messages exchanged in the individual multiple method steps A1, . . . , An; B1, . . . , Bn; C1, . . . , Cn and E1, . . . , En can of course change channel encodings and other user data and thus data volumes in the individual method sections are also variable.

The teachings of the present disclosure may be used to replace a previously known integrity protection, which is realized on the receiver side, by a downstream integration check by the transmitting control device CTR.

A suitable choice of expiry times of the cryptographic materials used can ensure that the time of a necessary renewal of cryptographic keys, certificates, etc. is coupled to existing deadlines for verification—for example, in accordance with statutory calibration requirements. In an embodiment of the control device CTR as a microcontroller and the auxiliary device DSP as a display device, the integrity-securing transmission can be carried out, for example, using a signature in connection with a certificate chain derived from a certificate. For example, the microcontroller could be set so as to trust the certificate and such that the validity of this certificate is limited to the initial statutory calibration period. The necessary key exchange can then be carried out by reprogramming or replacing the microcontroller, which could be qualified under statutory calibration law as the initial bringing of a new measuring device onto the market and thus does not incur any costs for an official inspection.

1. A method for the integrity-secured transmission of a measurement data point from a control device to an auxiliary device in communication with the control device, the method comprising:
collecting a measurement data set;
generating and maintaining a cryptographically secured first representation of the measurement data set in the control device;
sending a cryptographically unsecured transmission message containing the measurement data set to the auxiliary device;
receiving a confirmation message from the auxiliary device, the confirmation message containing a cryptographically secured second representation of the measurement data set;
checking the assignability of the received cryptographically secured second representation to the cryptographically secured first representation of the measurement data set provided in the control device; and
verifying the integrity of the transmitted measurement data set in the case of a positive result of the test.

2. The method as claimed in claim 1, wherein the cryptographically secured representation is generated with a cryptographic hash function or with a digital signature.

3. The method as claimed in claim 1, further comprising decrypting the received cryptographically secured second representation using a public signature key assignable to the auxiliary device before checking the assignability.

4. The method as claimed in claim 1, further comprising, after verification of the integrity of the transmitted measurement data set, signing the received cryptographically secured second representation with a private signature key assignable to the control device and sending the signed representation to the auxiliary device.

5. The method as claimed in claim 1, wherein the confirmation message received by the auxiliary device is sent in response to the transmission message.

6. The method as claimed in claim 1, further comprising, upon receipt of the confirmation message, performing a check as to whether said message has been sent in response to one of the transmission messages.

7. The method as claimed in claim 1, wherein the check of the assignability comprises checking for identity or agreement.

8. The method as claimed in claim 1, wherein the cryptographically secured representation is generated with a digital signature in conjunction with a certificate chain derived from a certificate.

9. The method as claimed in claim 8, wherein an initially set validity of said certificate or another certificate within the certificate chain is limited to an initial statutory calibration period of the control device and/or the auxiliary device.

10. A control device for the integrity-secured transmission of a measurement data point to an auxiliary device in communication with the control device, the control device programmed to:
collect a measurement data set;
generate and maintain a cryptographically secured first representation of the measurement data set;
sending a cryptographically unsecured transmission message containing the measurement data set to the auxiliary device;
receive a confirmation message from the auxiliary device, the confirmation message containing a cryptographically secured second representation of the measurement data set;
check the assignability of the received cryptographically secured second representation to the cryptographically secured first representation of the measurement data set provided in the control device; and
verify the integrity of the transmitted measurement data set in the case of a positive result of the test.
